(19) United States
(12) Patent Application Publication
(10) Pub. No.: US 2017/0302682 A1
(43) Pub. Date: Oct. 19, 2017

(54) DEVICE AND METHOD FOR ANALYZING MALWARE

(71) Applicant: FUJITSU LIMITED, Kawasaki-shi (JP)

(72) Inventors: Hirotaka KOKUBO, Minato (JP); Masahiko TAKENAKA, Kawasaki (JP); Kazuyoshi Furukawa, Kawasaki (JP); TAKANORI OIKAWA, Kawasaki (JP)

(73) Assignee: FUJITSU LIMITED, Kawasaki-shi (JP)

(21) Appl. No.: 15/432,141

(22) Filed: Feb. 14, 2017

(30) Foreign Application Priority Data
Apr. 13, 2016 (JP) 2016-080342

(51) Int. Cl. H04L 29/06; G06F 21/56

(52) U.S. Cl. CPC H04L 63/145; G06F 21/56; H04L 63/02

(57) ABSTRACT

A device for analyzing malware includes a memory and a processor coupled to the memory. The memory is configured to store therein an instruction assumed to be transmitted to an operating system from malware. The processor is configured to hook a first instruction transmitted to the operating system from an application. The processor is configured to determine whether the first instruction is stored in the memory. The processor is configured to copy data stored in first hardware to second hardware different from the first hardware upon determining that the first instruction is stored in the memory. The first hardware is accessed by the operating system.

### CROSS-REFERENCE TO RELATED APPLICATION

This application is based upon and claims the benefit of priority of the prior Japanese Patent Application No. 2016-080342, filed on Apr. 13, 2016, the entire contents of which are incorporated herein by reference.

### FIELD

The embodiments discussed herein are related to a device and method for analyzing malware.

### BACKGROUND

A security administrator (in the following, also referred to as simply an administrator) in an organization or an enterprise needs to prevent illegal acquisition, destruction, or the like of information (in the following, also referred to as a malignant operation) caused by a program or the like (in the following, also referred to as malware) performs harmful operations, which includes, for example, computer virus.

Specifically, malware is transmitted in the form attached to an email transmitted from an external terminal device (in the following, also referred to as simply an external terminal) by, for example, a malicious party and is executed in a terminal device receiving the email to infect the terminal device. Accordingly, for example, by making a steppingstone of the terminal device infected with malware, the malicious party is able to perform an unauthorized access to other terminal devices (e.g., terminal devices storing confidential information) coupled to the infected terminal device.

For that reason, when an execution file is attached to an email transmitted from, for example, an external terminal, to a terminal device, the administrator causes a verification device (e.g., a device having a virtual environment implemented in a virtual machine) to execute the execution file. Specifically, when an execution file is attached to an email transmitted from an external terminal to a terminal device, the verification device acquires the email before being transmitted to the terminal device. The verification device executes and analyzes the execution file attached to the acquired email in the virtual environment.

Accordingly, the administrator may determine whether the execution file attached to the email is malware, before the email transmitted from an external terminal is transmitted to the terminal device. Therefore, when it is determined that the execution file attached to the email transmitted from an external terminal is malware, the administrator may discard the email without allowing the email to be transmitted to the terminal device. In this case, the administrator may acquire information (an analysis result) about details of operations performed by the malware.

Related techniques are disclosed in, for example, Japanese Laid-Open Patent Publication No. 2013-239149, Japanese National Publication of International Patent Application No. 2014-519113, and Japanese Laid-Open Patent Publication No. 2012-022466.

### SUMMARY

According to an aspect of the present invention, provided is a device for analyzing malware. The device includes a memory and a processor coupled to the memory. The memory is configured to store therein an instruction assumed to be transmitted to an operating system from malware. The processor is configured to hook a first instruction transmitted to the operating system from an application. The processor is configured to determine whether the first instruction is stored in the memory. The processor is configured to copy data stored in first hardware to second hardware different from the first hardware upon determining that the first instruction is stored in the memory. The first hardware is accessed by the operating system.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating a configuration of an information processing system;

FIG. 2 is a diagram illustrating a specific example in a case where a malicious party transmits malware to a terminal device;

FIG. 3 is a diagram illustrating a verification device included in an information processing system;

FIG. 4 is a diagram illustrating a specific example of processing of a verification device when malware having the analysis-resistant function is received;

FIG. 5 is a diagram illustrating a case where contents of malware are disassembled;

FIG. 6 is a diagram illustrating a hardware configuration of a terminal device;

FIG. 7 is a diagram illustrating a functional configuration of a terminal device of FIG. 6;

FIG. 8 is a flowchart illustrating a flow of a malware analysis process according to a first embodiment;

FIG. 9 is a flowchart illustrating a flow of a malware analysis process according to the first embodiment;

FIG. 10 is a diagram illustrating a malware analysis process according to the first embodiment;

FIG. 11 is a diagram illustrating a malware analysis process according to the first embodiment;

FIG. 12 is a diagram illustrating a malware analysis process according to the first embodiment;

FIG. 13 is a flowchart illustrating a flow of a malware analysis process according to the first embodiment;

FIG. 14 is a flowchart illustrating a flow of a malware analysis process according to the first embodiment;

FIG. 15 is a flowchart illustrating a flow of a malware analysis process according to the first embodiment;

FIG. 16 is a diagram illustrating a specific example of instruction information;

FIG. 17 is a flowchart illustrating a flow of a malware analysis process according to a second embodiment;

FIG. 18 is a flowchart illustrating a flow of a malware analysis process according to the second embodiment;

FIG. 19 is a flowchart illustrating a flow of a malware analysis process according to the second embodiment; and

FIG. 20 is a diagram illustrating a specific example of instruction information according to the second embodiment.

### DESCRIPTION OF EMBODIMENTS

Among the types of malware, for example, there is malware which terminates its operation without performing any malignant operations when detecting that the malware is executed in a virtual environment. Specifically, when detecting that the malware is executed in a virtual environment, such malware determines that operations of itself may be analyzed and terminates its operation in order to prevent its operation from being analyzed (in the following, such a function is also referred to as an analysis-resistant function). For that reason, the verification device may be unable to determine that an execution file attached to an email is malware and may transmit an email, to which malware is attached, to a terminal device depending on the type of malware.

The administrator, for example, may disassemble contents of malware into a form capable of being read by a human being to analyze operations performed by the malware after a terminal device is infected with the malware. Accordingly, the administrator may analyze contents of operations performed by the malware.

However, among the types of malware, there is malware attached to an email or the like, for example, in a state of being encrypted by a program such as a packer. Such malware performs its decoding by a program such as an unpacker, for example, only when execution of the malware itself is started. Therefore, the administrator is unable to analyze malware by disassembling in some cases.

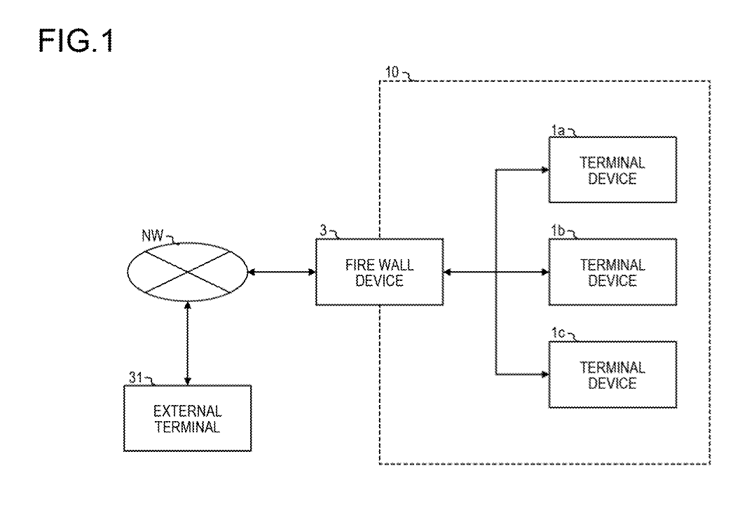

FIG. 1 is a diagram illustrating a configuration of an information processing system 10. The information processing system 10 illustrated in FIG. 1 includes terminal devices 1a, 1b, and 1c (in the following, the devices are also collectively referred to as a terminal device 1 or malware analysis device 1) and a fire wall device 3.

The terminal device 1 is a terminal used by an administrator or a developer of a business system in an organization or an enterprise. Specifically, the terminal device 1 is, for example, a desktop personal computer (PC) or a notebook PC.

The fire wall device 3 controls communication between the terminal device 1 and an external terminal 31 coupled to a network NW. That is, the fire wall device 3 defends, for example, an unauthorized access or the like to the terminal device 1 by the external terminal 31. The network NW is, for example, the Internet.

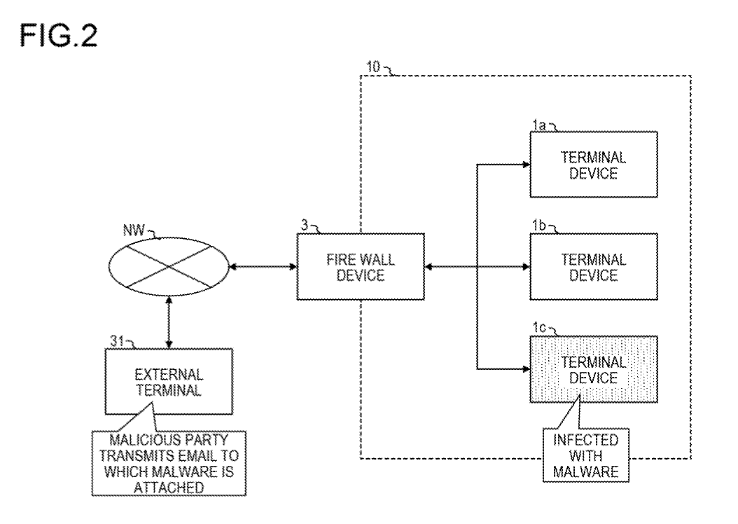

Next, a specific example of a case where a malicious party transmits malware to the terminal device 1c through the external terminal 31 will be described. FIG. 2 is a diagram illustrating a specific example in a case where a malicious party transmits malware to the terminal device 1c.

The malicious party, as illustrated in FIG. 2, transmits an email (an email pretending to be a normal email) attached with malware to the terminal device 1c through, for example, the external terminal 31. Specifically, the malicious party determines, in advance, a target (a specific enterprise or the like) for which illegal acquisition or the like of information is intended, and transmits an email to which malware is attached to a terminal device (terminal device 1c) of the target (this is called a targeted attack).

In this case, the fire wall device 3 may be unable to determine that malware is attached to the email transmitted from the external terminal 31, and thus, does not discard the email. Therefore, as illustrated in FIG. 2, the terminal device 1c may be infected with the malware attached to the transmitted email when a user executes the malware.

Accordingly, for example, the administrator provides a verification device 2, which performs analysis of malware and the like, between the terminal device 1 and the fire wall device 3. In the following, the verification device 2 will be described.

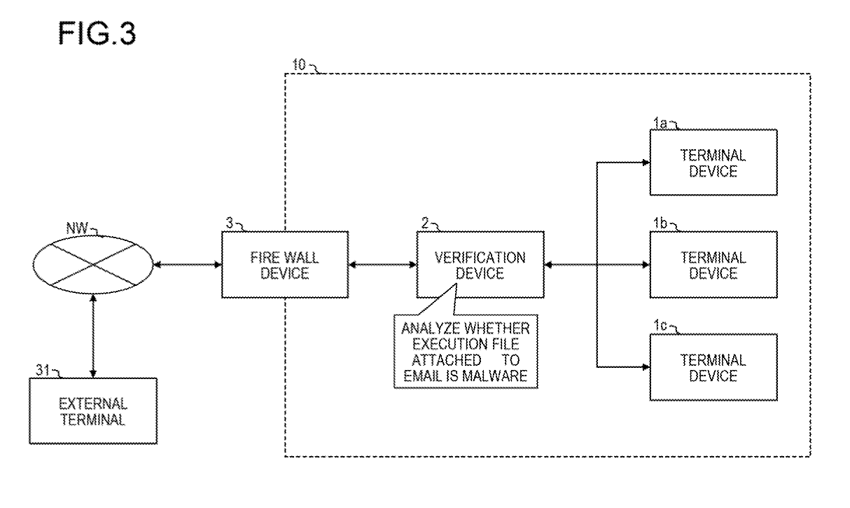

FIG. 3 is a diagram illustrating the verification device 2 included in the information processing system 10. For example, when an email for the terminal device 1 is transmitted from the external terminal 31, the verification device 2 acquires the transmitted email and determines whether an execution file is attached to the email. When it is determined that an execution file is attached to the email transmitted from the external terminal 31, the verification device 2 executes the execution file attached to the email in a virtual environment constructed within the verification device 2. The virtual environment constructed within the verification device 2 is, for example, an environment consisting of virtual machines (in the following, also referred to as VMs) which are generated by being assigned with physical resources of the verification device 2.

That is, the fire wall device 3 is unable to detect that the execution file attached to the email is malware and thus, may permit a communication. Therefore, the verification device 2 executes the execution file attached to the email, which has passed through the fire wall device 3, and analyzes the execution file so as to determine whether the execution file is malware.

Accordingly, the administrator may analyze contents of operations of malware attached to an email transmitted from the external terminal 31. The administrator may prevent the email to which malware is attached from being transmitted to the terminal device 1.

However, among types of malware, there is malware having, for example, an analysis-resistant function. In the following, processing of the verification device 2 for malware having the analysis-resistant function will be described.

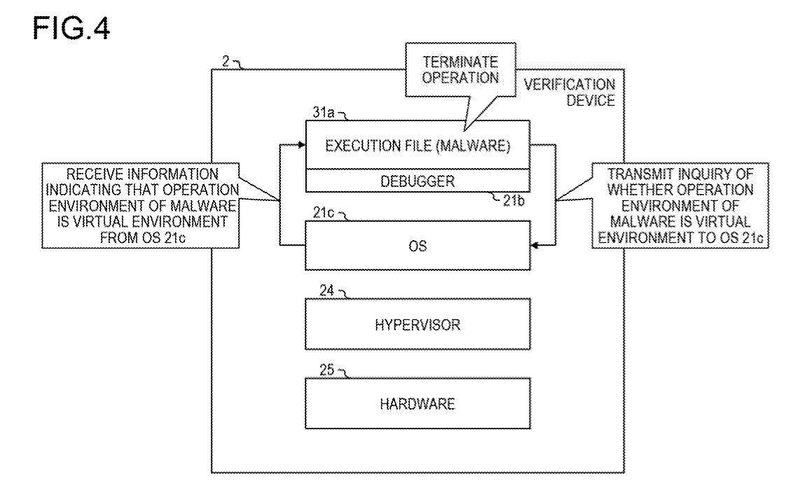

FIG. 4 is a diagram illustrating a specific example of processing of the verification device 2 when malware having the analysis-resistant function is received.

In the verification device 2 illustrated in FIG. 4, a hypervisor 24 operates on hardware 25 (physical resource) of the verification device 2 to generate or delete a virtual machine. Specifically, when a virtual machine is generated in the verification device 2, the hypervisor 24 generates an operating system (OS) 21c (this is called a guest OS) on the hypervisor 24 and allocates a portion of the hardware 25 as hardware (in the following, also referred to as virtual hardware) of the virtual machine. When the virtual machine generated in the verification device 2 is deleted, the hypervisor 24 deletes the OS 21c generated on the hypervisor 24 and releases the virtual hardware of the virtual machine.

In the verification device 2 illustrated in FIG. 4, a debugger 21b for executing and analyzing, for example, an execution file 31a (an execution file which may be malware) attached to an email transmitted from the external terminal 31 operates on the OS 21c.

Specifically, when the execution file 31a executed in the verification device 2 is malware, as illustrated in FIG. 4, the malware determines whether the current execution environment in which the malware is executed is an environment in which operations of malware are to be continued (environment in which a malignant operation is to be started). That is, for example, the malware determines whether the execution environment is a virtual environment. When it is determined that the execution environment is a virtual environment, the malware determines that the execution environment is a virtual environment for analyzing the malware itself. Then, the malware determines that the execution environment is not the environment in which operations of the malware are to be continued, and terminates its operation. Accordingly, the malware prevents its operations from being analyzed.

More specifically, as illustrated in FIG. 4, the malware transmits, to the OS 21c, an instruction (in the following, also referred to as VM detection instruction) for requesting information on whether the execution environment is a virtual environment, that is, whether the malware is executed in a virtual environment. When information indicating that the execution environment is a virtual environment is received from the OS 21c, the malware terminates its operation. That is, in this case, the malware determines that the current environment in which the malware is executed is not an environment in which operations of malware are to be continued and does not perform the operation for performing the malignant operation. Therefore, in this case, the verification device 2 is unable to detect that the execution file 31a attached to the transmitted email is malware.

The administrator may disassemble contents of malware into a form capable of being read by a human being to analyze operations performed by the malware. In the following, disassembling of contents of the malware will be described.

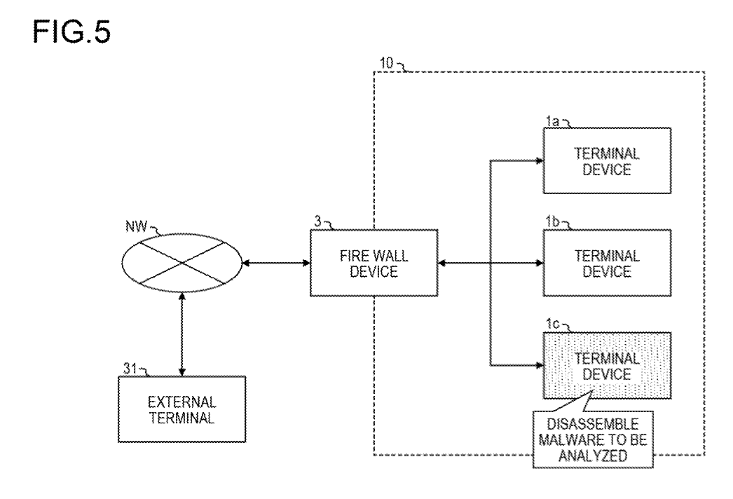

FIG. 5 is a diagram illustrating a case where contents of malware are disassembled. As illustrated in FIG. 5, for example, the administrator disassembles contents of malware into a form capable of being read by a human being and references the disassembled contents of the malware. Accordingly, the administrator may analyze operations of the malware even after a malware infection.

However, among the types of malware, there is malware attached to an email or the like, for example, in a state of being encrypted by a program such as a packer. Such malware performs its decoding by a program such as an unpacker, for example, only when execution of the malware itself is started. Therefore, the administrator is unable to analyze contents of malware even by disassembling in some cases.

According to the present embodiment, the terminal device 1 registers in advance an instruction assumed to be transmitted from malware to the OS. Then, the terminal device 1 hooks an instruction (in the following, also referred to as a specific instruction) transmitted to the OS from an application (an application including the execution file 31a attached to an email transmitted from the external terminal 31). Thereafter, when the hooked specific instruction is already registered in a storage unit, the terminal device 1 copies data stored in hardware to other hardware.

That is, as described with reference to FIG. 4, among types of malware, there is malware transmitting, for example, a VM detection instruction to the OS. Thus, when an application operating on the OS transmits a VM detection instruction to the OS, the terminal device 1 determines that the application having transmitted the VM detection instruction may be malware itself or an application infected with malware. In this case, the terminal device 1 copies data stored in hardware, onto which writing is made by an application that may be malware itself (an application which may be infected with malware), to other hardware.

Accordingly, the terminal device 1 may save data, which is written in hardware during the operation of malware, in other hardware. Therefore, the administrator may maintain data written by malware even after the malware has terminated its operation. Accordingly, the administrator may reference the data (saved in other hardware) written onto hardware during the operation of malware and analyze contents of the operations of the malware ex-post facto.

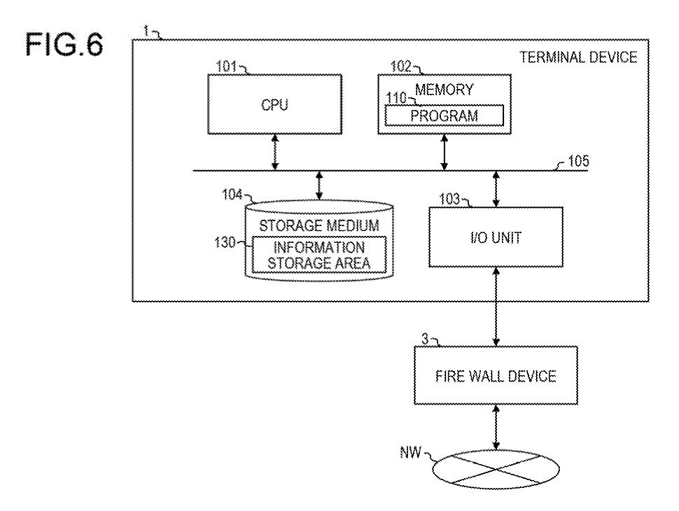

Next, a hardware configuration of the terminal device 1 will be described. FIG. 6 is a diagram illustrating a hardware configuration of the terminal device 1.

The terminal device 1 includes a central processing unit (CPU) 101 which is a processor, a memory 102, an external interface 103 (I/O unit), and a storage medium 104. Respective components are coupled to each other through a bus 105.

The storage medium 104 stores a program 110 for performing processing (in the following, also referred to as a malware analysis process) of analyzing malware, etc., for example, in a program storage area (not illustrated) within the storage medium 104. The storage medium 104 is, for example, a hard disk drive (HDD) or a solid state drive (SSD).

The CPU 101, as illustrated in FIG. 6, loads the program 110 from the storage medium 104 to the memory 102 when the program 110 is executed, and performs, for example, a malware analysis process in cooperation with the program 110.

The storage medium 104 includes an information storage area 130 (in the following, also referred to as a storage unit 130) which stores therein information used in, for example, performing the malware analysis process or the like. The storage unit 130 functions as, for example, a storage unit controlled by the hypervisor of the terminal device 1.

The external interface 103 communicates with the network NW through the fire wall device 3.

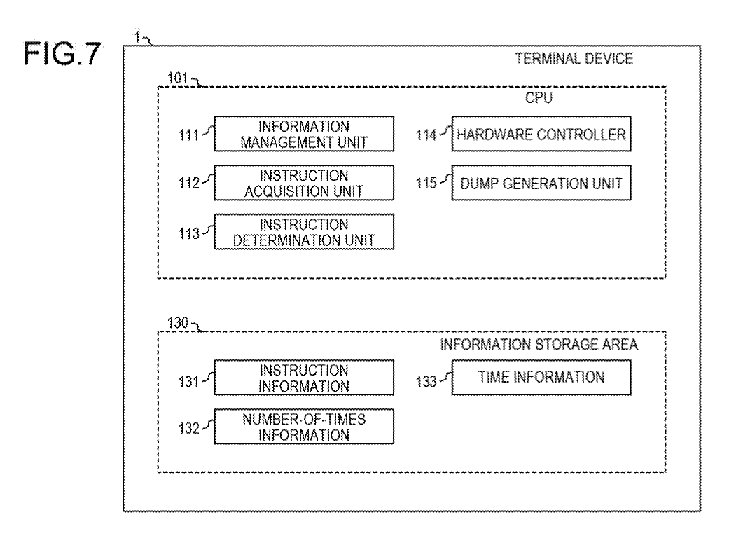

Next, a software configuration of the terminal device 1 will be described. FIG. 7 is a diagram illustrating a functional configuration of the terminal device 1 of FIG. 6. The CPU 101 cooperates with the program 110 to function as an information management unit 111, an instruction acquisition unit 112, an instruction determination unit 113, a hardware controller 114, and a dump generation unit 115, which are functions of the hypervisor of the terminal device 1. The information storage area 130 stores therein instruction information 131, number-of-times information 132, and time information 133.

The information management unit 111 registers, in the information storage area 130, an instruction assumed to be transmitted from malware to the OS, as the instruction information 131.

The instruction acquisition unit 112 hooks an instruction transmitted to the OS from an application. The instruction determination unit 113 determines whether information corresponding to the instruction hooked by the instruction acquisition unit 112 is included in the instruction information 131 registered in the information storage area 130.

When it is determined that information corresponding to the instruction hooked by the instruction acquisition unit 112 is included in the instruction information 131, the hardware controller 114 copies data stored in hardware to other hardware.

The dump generation unit 115 generates a dump file (not illustrated) from data stored in the other hardware in response to, for example, an input to the terminal device 1 by the administrator. In the following, description will be made by regarding the other hardware as the storage medium 104. However, the other hardware may be, for example, a storage medium different from the storage medium 104. The other hardware may be, for example, a memory different from the memory 102. The number-of-times information 132 and the time information 133 will be described later.

### First Embodiment

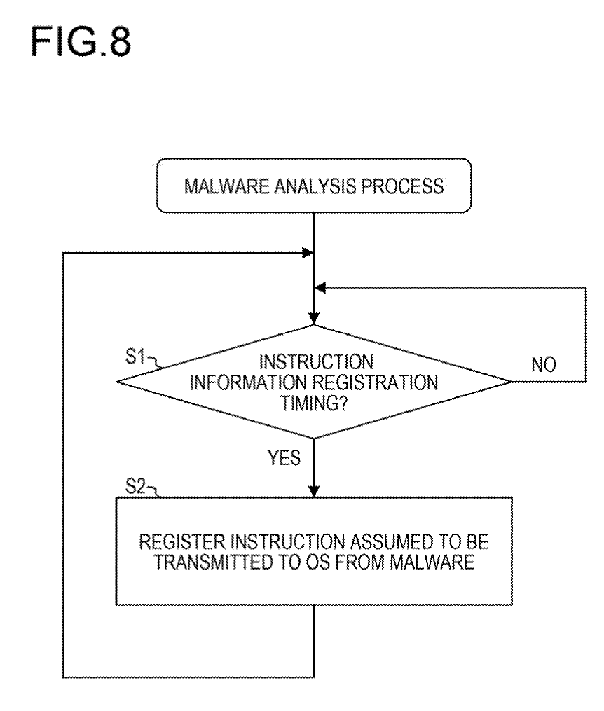

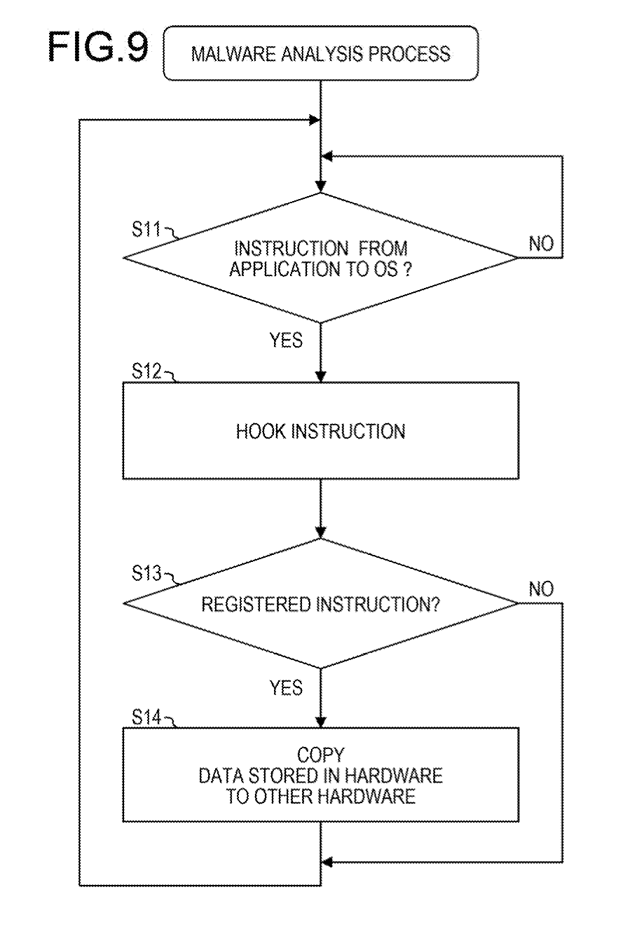

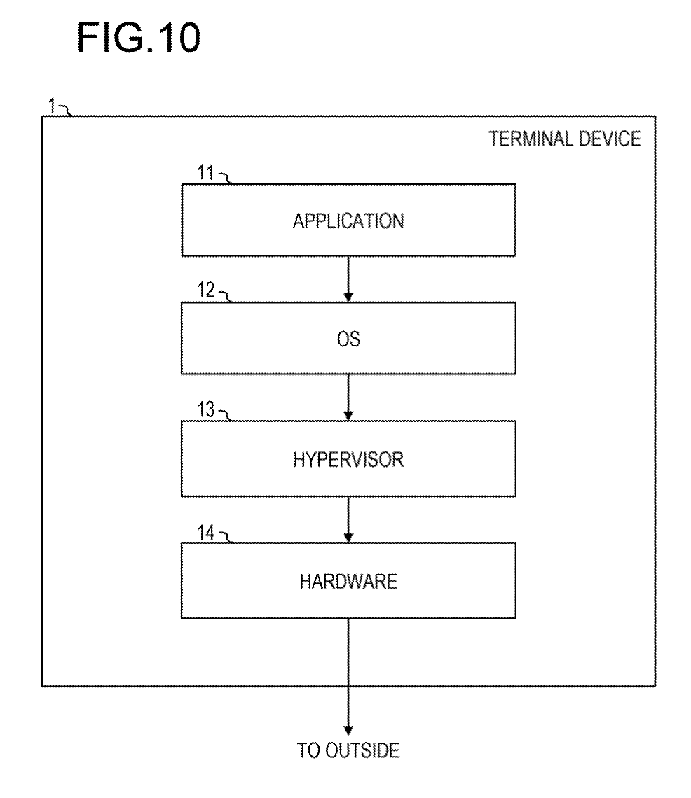

Next, a first embodiment will be described. FIGS. 8 and 9 are flowcharts illustrating a flow of a malware analysis process according to the first embodiment. FIGS. 10 to 12 are diagrams illustrating the malware analysis process according to the first embodiment. The malware analysis process will be described with reference to FIGS. 8 to 12.

First, a configuration of the terminal device 1 will be described. FIG. 10 illustrates a configuration of the terminal device 1.

In the terminal device 1 illustrated in FIG. 10, a hypervisor 13 operates on hardware 14 (physical resource) of the terminal device 1 to generate or delete a virtual machine. Specifically, when the virtual machine is generated in the terminal device 1, the hypervisor 13 generates an OS 12 on the hypervisor 13 and allocates a portion of the hardware 14 as virtual hardware of the virtual machine. When the virtual machine generated in the terminal device 1 is deleted, the hypervisor 13 deletes the OS 12 generated on the hypervisor 13 and releases the virtual hardware of the virtual machine.

Although the hypervisor 13 illustrated in FIG. 10 directly operates on the hardware 14, the hypervisor 13 may be a hypervisor operating on a host OS (not illustrated) that operates on the hardware 14. That is, the hypervisor 13 illustrated in FIG. 10 is not a hypervisor operating on the host OS, but a hypervisor (Type 1 hypervisor) directly operating on the hardware 14. In contrast, the hypervisor 13 may be a hypervisor (Type 2 hypervisor) that operates on a host OS directly operating on the hardware 14.

Next, the flow of the malware analysis process will be described with reference to the flowcharts illustrated in FIGS. 8 and 9. As illustrated in FIG. 8, the hypervisor 13 of the terminal device 1 waits until the instruction information registration timing is reached (NO at S1). The instruction information registration timing is the timing at which the instruction information 131 is registered in the information storage area 130. Specifically, the instruction information registration timing may be the timing, for example, at which the administrator inputs the instruction information 131 into the terminal device 1. When it is determined that the instruction information registration timing is reached (YES at S1), the hypervisor 13 registers the instruction information 131 in the information storage area 130 (S2).

That is, the hypervisor 13 registers in advance, as the instruction information 131, information identifying an instruction (VM detection instruction) assumed to be transmitted to the OS 12 by malware when the malware operates on the OS 12 of the terminal device 1. Accordingly, the hypervisor 13, as will be described later, may determine whether an application 11 having transmitted an instruction to the OS 12 is malware itself (whether the application 11 is an application infected with malware) by hooking the instruction.

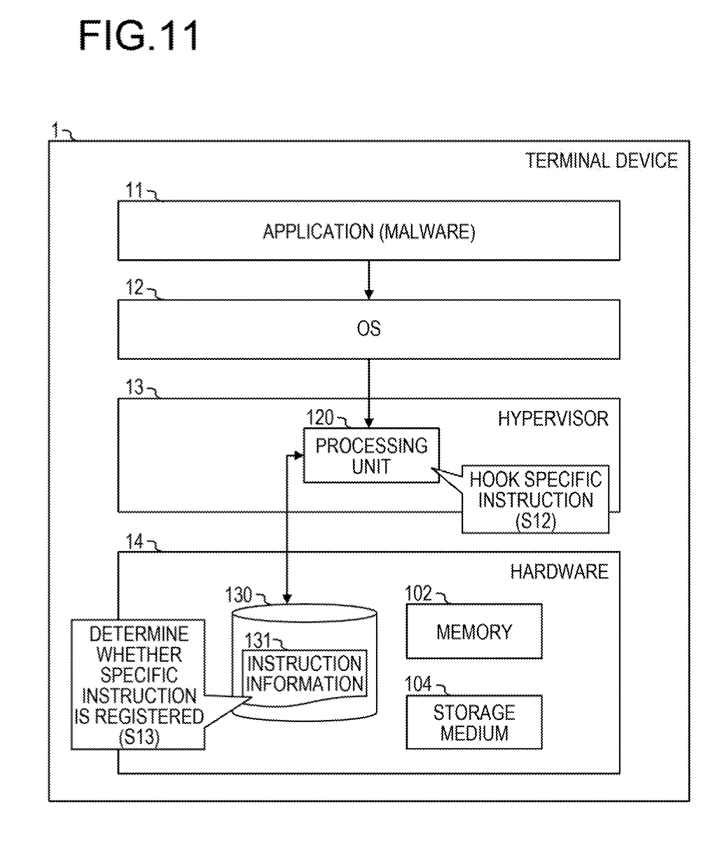

Thereafter, the hypervisor 13, as illustrated in FIG. 9, waits until an instruction is transmitted to the OS 12 from an application 11 (NO at S11). When it is detected that an instruction is transmitted from an application 11 to the OS 12 (YES at S11), the hypervisor 13 hooks the detected instruction (specific instruction) as illustrated in FIG. 11 (S12).

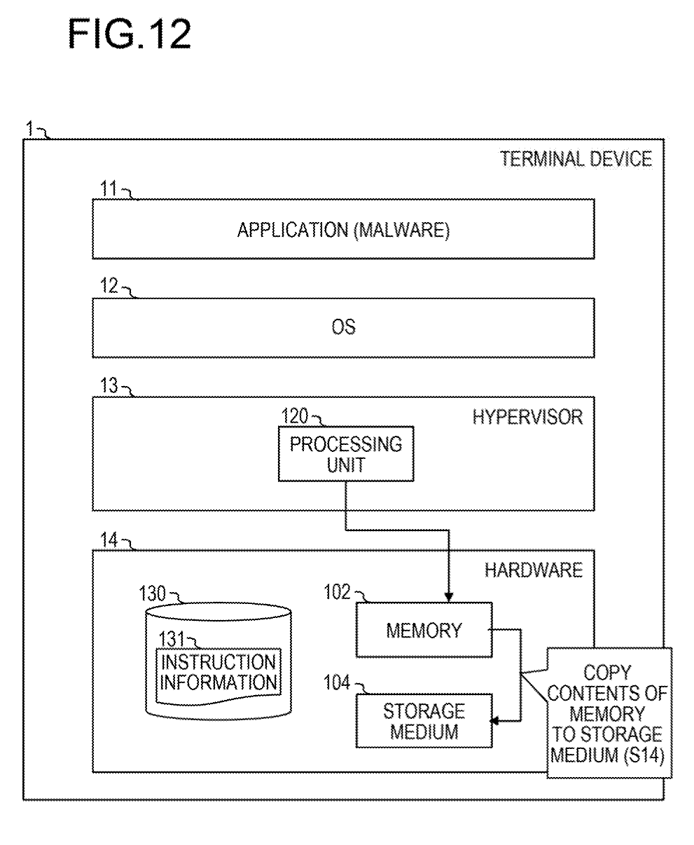

Next, the hypervisor 13, as illustrated in FIG. 11, determines whether information corresponding to the instruction hooked at S12 is included in the instruction information 131 registered in the information storage area 130 (S13). When it is determined that the information corresponding to the hooked instruction is included in the instruction information 131 (YES at S13), the hypervisor 13, as illustrated in FIG. 12, copies data stored in hardware (e.g., the memory 102) to other hardware (e.g., the storage medium 104) (S14).

That is, in a case where a VM detection instruction, of which information is included in the instruction information 131, is transmitted, the hypervisor 13 determines that the application 11 having transmitted the VM detection instruction may be malware itself or an application infected with malware. Then, the terminal device 1 copies data currently stored in the memory 102, onto which the malware performs writing, to the storage medium 104.

As described above, according to the first embodiment, the hypervisor 13 registers an instruction assumed to be transmitted to the OS 12 from malware. The hypervisor 13 hooks an instruction transmitted to the OS 12 from the application 11 (an application including an execution file attached to an email transmitted from the external terminal 31). When the hooked specific instruction is already registered in the information storage area 130, the hypervisor 13 copies, for example, data stored in the memory 102 to the storage medium 104 which is other hardware.

Accordingly, the terminal device 1 may save data, which is written in the memory 102 during the operation of malware (the application 11 that may be determined to be malware), in the storage medium 104. Thus, the administrator may reference the data stored in the storage medium 104 and analyze contents of the operations of the malware ex-post facto.

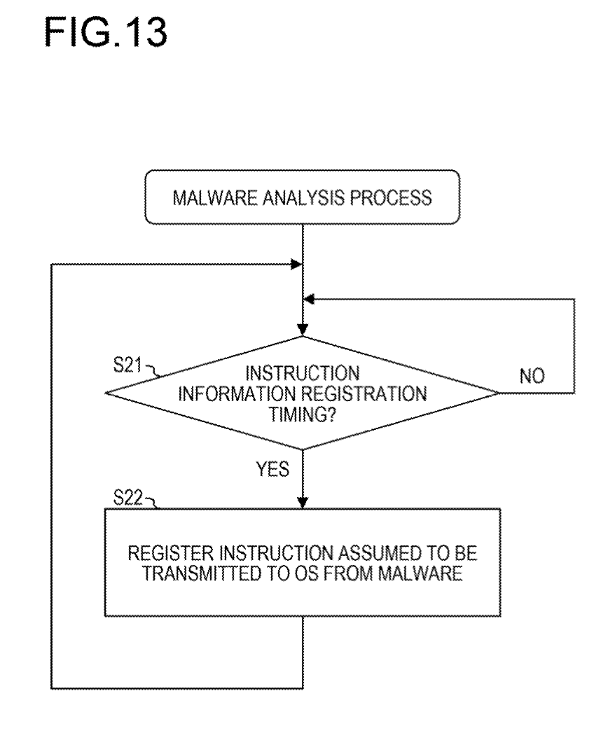

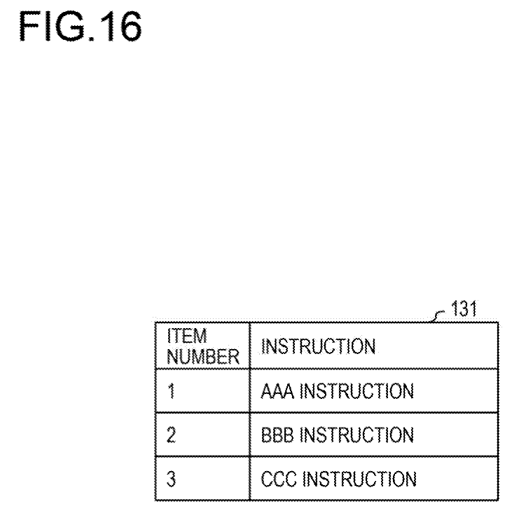

Next, the first embodiment will be described in detail. FIGS. 13 to 15 are flowcharts illustrating the flow of the malware analysis process according to the first embodiment. FIG. 16 is a diagram illustrating a specific example of the instruction information 131. The malware analysis process will be described with reference to FIGS. 13 to 16.

The information management unit 111, as illustrated in FIG. 13, waits until the instruction information registration timing is reached (NO at S21). When it is determined that the instruction information registration timing is reached (YES at S21), the information management unit 111 registers the instruction information 131 in the information storage area 130 (S22). In the following, a specific example of the instruction information 131 will be described.

As illustrated in FIG. 16, each item of the instruction information 131 includes “item number” field in which an item number identifying each piece of information included in the instruction information 131 and “instruction” field in which an instruction (VM detection instruction) assumed to be transmitted from malware is set.

Specifically, in the instruction information 131 illustrated in FIG. 16, an “AAA instruction” is set in the “instruction” field of the item having “1” in the “item number” field, a “BBB instruction” is set in the “instruction” field of the item having “2” in the “item number” field, and a “CCC instruction” is set in the “instruction” field of the item having “3” in the “item number”.

That is, the information management unit 111 registers in advance, in the information storage area 130, the instruction information 131 which identifies each instruction assumed to be transmitted to the OS 12 by the malware when the application 11 is malware itself (the application 11 is infected with malware).

The information management unit 111 may include, in the instruction information 131, information for identifying an instruction other than the VM detection instruction, which is assumed to be transmitted by the malware. For example, the information management unit 111 may include, in the instruction information 131, information for identifying a debugger detection instruction used by the malware to inquire whether the operation environment of the malware is a program such as, for example, a debugger. Accordingly, the instruction determination unit 113 may detect malware more accurately.

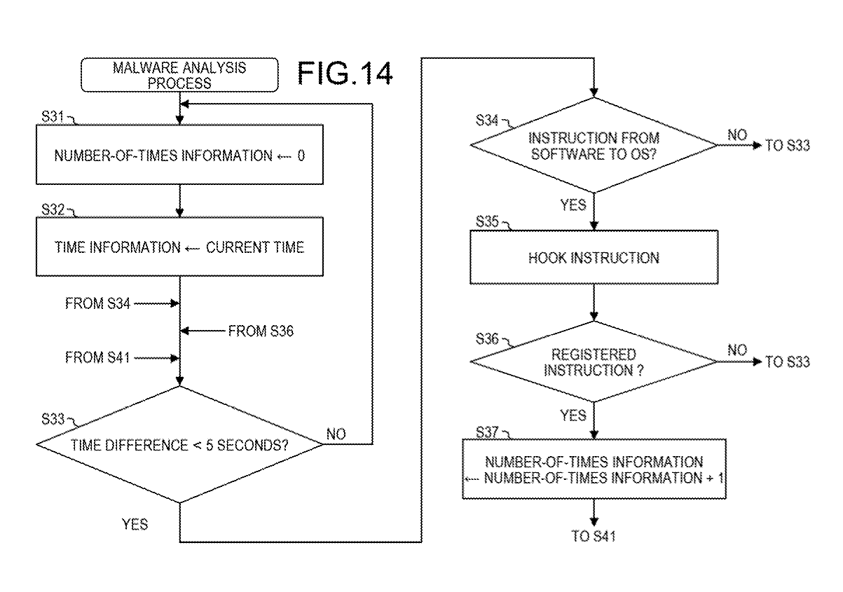

Referring back to FIG. 14, the instruction determination unit 113 sets “0” in number-of-times information 132 (S31). The number-of-times information 132 is information indicating the number of times that instructions are transmitted by the application 11 within a predetermined period of time.

That is, an instruction, of which information is included in the instruction information 131, may be transmitted by an application 11 not infected with malware. Therefore, in a case where data stored in the memory 102 is saved each time when the instruction, of which information is included in the instruction information 131, is transmitted from the application 11, the hypervisor 13 is unable to efficiently save data stored in the memory 102.

Thus, as will be described later, for example, when the number of times of transmission of any instruction, of which information is included in the instruction information 131, exceeds a predetermined number of times within a predetermined period of time, the hypervisor 13 considers that the application 11 may be malware and saves data stored in the memory 102. Accordingly, the hypervisor 13 may efficiently save data stored in the memory 102.

The instruction determination unit 113 sets the current time in the time information 133 in which the time at the predetermined timing is maintained (S32).

Thereafter, the instruction determination unit 113 determines whether, for example, a difference between the current time and the time set in the time information 133 is within five seconds (S33). When it is determined that the difference between the current time and the time set in the time information 133 is within five seconds (YES at S33), the instruction acquisition unit 112 determines whether an instruction is transmitted from the application 11 to the OS 12 (S34). When it is determined that an instruction is transmitted from the application 11 to the OS 12 (YES at S34), the instruction acquisition unit 112 hooks the instruction detected at S34 (S35). When it is determined that an instruction is not transmitted from the application 11 to the OS 12 (NO at S34), the instruction determination unit 113 executes S33 again.

When it is determined that the difference between the current time and the time set in the time information 133 reaches five seconds (NO at S33), the instruction determination unit 113 executes S31 again.

The instruction determination unit 113 determines whether information corresponding to the instruction hooked at S35 is included in the instruction information 131 registered in the information storage area 130 (S36). When it is determined that the information corresponding to the hooked instruction is included in the instruction information 131 (YES at S36), the instruction determination unit 113 adds “1” to a value set in the number-of-times information 132 (S37).

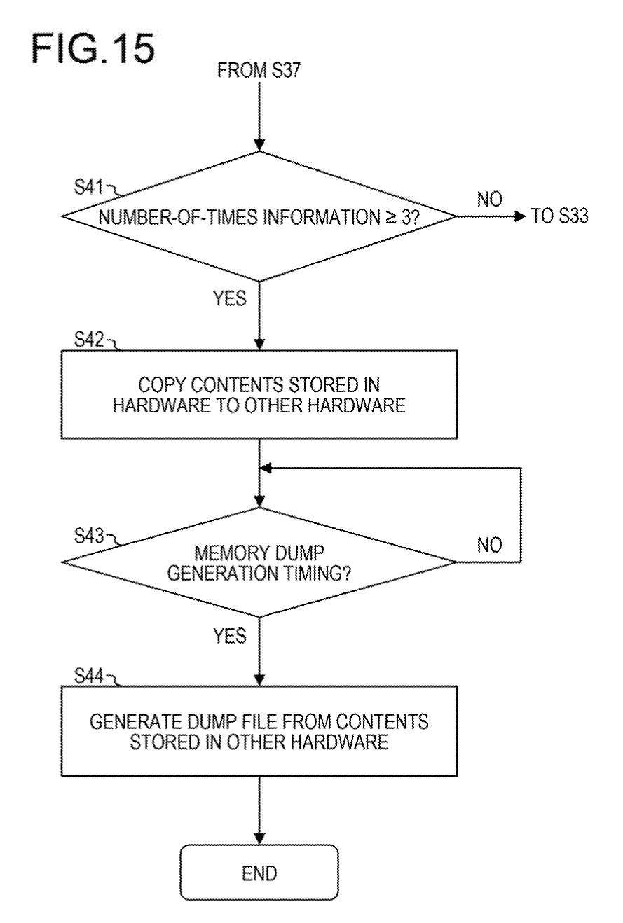

Thereafter, as illustrated in FIG. 15, the instruction determination unit 113 determines whether the value currently set in the number-of-times information 132 is greater than or equal to, for example, “3” (S41). When it is determined that the value set in the number-of-times information 132 is greater than or equal to “3” (YES at S41), the hardware controller 114 copies data stored in hardware (e.g., the memory 102) to other hardware (e.g., the storage medium 104) (S42).

That is, the instruction determination unit 113 determines that the application 11 may be malware (an application infected with malware) not each time when any instruction, of which information is included in the instruction information 131, is transmitted but when any instruction, of which information is included in the instruction information 131 is transmitted, for example, three times or more within five seconds. Accordingly, the hardware controller 114 may efficiently save data stored in the memory 102.

The instruction determination unit 113 may update the value set in the number-of-times information 132 for each instruction (each item of the instruction information 131 described in FIG. 16) at S37. The instruction determination unit 113 may determine whether an instruction transmitted three times or more within five seconds is present among the instructions, of which information is included in the instruction information 131 at S41. Accordingly, the instruction determination unit 113 may save data stored in the memory 102 only when transmission of the same instruction is performed a predetermined number of times within a predetermined period of time.

When it is determined, at S36, that the information corresponding to the hooked instruction is included in the instruction information 131 registered in the information storage area 130, the hypervisor 13 may control the operation of the OS 12 to be stopped. Accordingly, the hypervisor 13 may perform saving of data stored in the memory 102 by the hardware controller 114 at S42 before the operation of the malware is terminated.

Furthermore, when it is determined, at S36, that the information corresponding to the hooked instruction is included in the instruction information 131 registered in the information storage area 130, the hypervisor 13 may control an operation speed of the CPU 101 of the terminal device 1 to be decreased. Accordingly, the hypervisor 13 may slow down the operation speed of the malware.

Thereafter, the dump generation unit 115 waits until the memory dump generation timing is reached (NO at S43). The memory dump generation timing may be, for example, the timing at which the administrator inputs, to the terminal device 1, an instruction for generating the dump file. When it is determined that the memory dump generation timing is reached (YES at S43), the dump generation unit 115 generates a dump file from data stored in other hardware (the storage medium 104) (S44). The generated dump file may be saved in the storage medium 104 or another storage medium. The generated dump file may be output to an output device (not illustrated) or be transmitted to other devices through the external interface 103.

When it is determined that the information corresponding to the hooked instruction is not included in the instruction information 131 (NO at S36), the instruction determination unit 113 performs S33 again. When it is determined that the value set in the number-of-times information 132 is not greater than or equal to “3” (NO at S41), the instruction determination unit 113 performs S33 again.

As described above, according to the first embodiment, the hypervisor 13 registers an instruction assumed to be transmitted to the OS 12 from malware. The hypervisor 13 hooks an instruction transmitted to the OS 12 from the application 11 (an application including an execution file attached to an email transmitted from the external terminal 31). Thereafter, when the hooked specific instruction is already registered in the information storage area 130, the hypervisor 13 copies, for example, data stored in the memory 102 to the storage medium 104 which is other hardware

Accordingly, the terminal device 1 may save data, which is written in hardware during the operation of malware, in other hardware. Therefore, the administrator may maintain data written by malware even after the malware has terminated its operation. Accordingly, the administrator may reference the data written onto hardware during the operation of the malware and analyze contents of the operations of the malware later.

### Second Embodiment

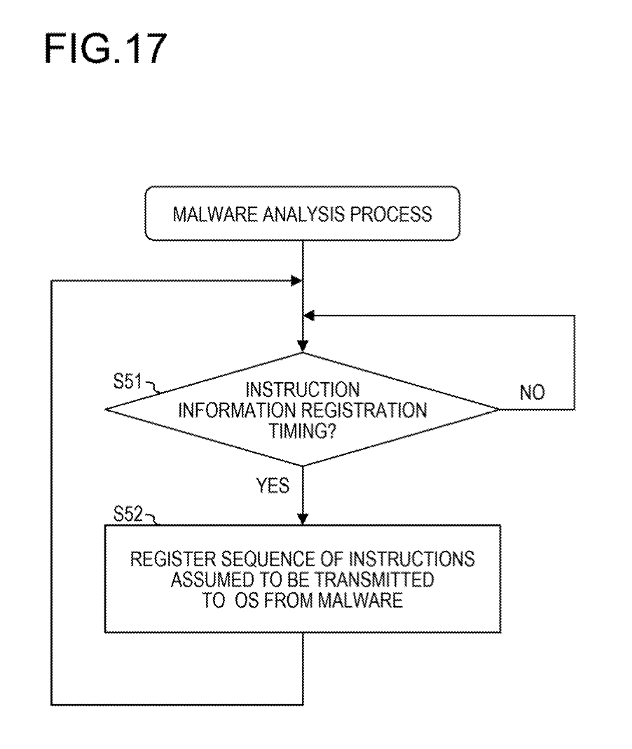

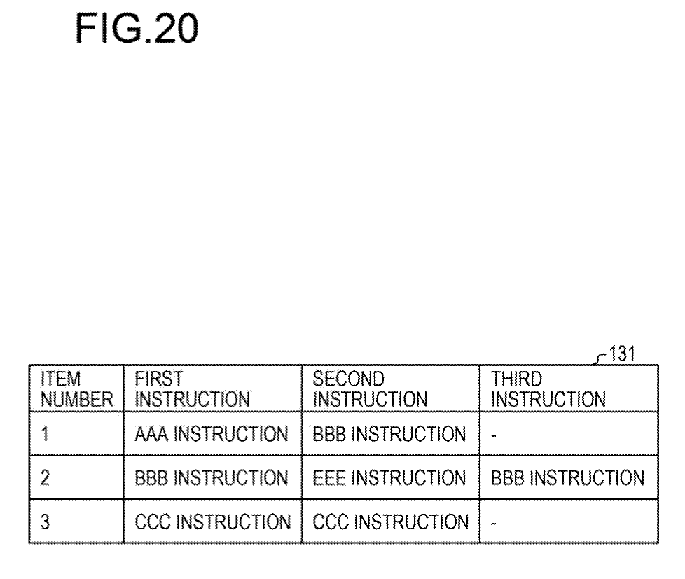

Next, a second embodiment will be described. FIGS. 17 to 19 are flowcharts illustrating a flow of a malware analysis process according to the second embodiment. FIG. 20 is a diagram illustrating a specific example of the instruction information 131 according to the second embodiment. The malware analysis process will be described with reference to FIGS. 17 to 20.

In the malware analysis process according to the second embodiment, when pieces of information corresponding to a sequence of a plurality of instructions assumed to be transmitted to the OS 12 by the application 11 are included in the instruction information 131, it is determined that malware operates on the OS 12.

Accordingly, when an operation characteristic of malware is obvious, the hypervisor 13 may precisely discern an instruction transmitted by malware and an instruction transmitted by an application 11 not infected with malware. Therefore, the hypervisor 13 may more efficiently save data stored in the memory 102. In the following, the malware analysis process according to the second embodiment will be described in detail.

As illustrated in FIG. 17, the information management unit 111 waits until the instruction information registration timing is reached (NO at S51). When it is determined that the instruction information registration timing is reached (YES at S51), the information management unit 111 registers the instruction information 131 in the information storage area 130 (S52). The instruction information 131 according to the second embodiment is information corresponding to a sequence of instructions assumed to be transmitted to the OS 12 from malware. In the following, a specific example of the instruction information 131 according to the second embodiment will be described.

As illustrated in FIG. 20, each item of the instruction information 131 includes an “item number” field in which an item number identifying each piece of information included in the instruction information 131 and an “first instruction” field in which an instruction assumed to be transmitted from malware is set. Each item of the instruction information 131 illustrated in FIG. 20 also includes a “second instruction” field in which an instruction assumed to be transmitted from the malware subsequent to the instruction set in the “first instruction” field is set, and a “third instruction” field in which an instruction assumed to be transmitted from the malware subsequent to the instruction set in the “second instruction” field is set.

Specifically, in the instruction information 131 illustrated in FIG. 20, an “AAA instruction” is set in the “first instruction” field of the item having “1” in the “item number” field, a “BBB instruction” is set in the “second instruction” field, and a symbol “−” indicating that information is not set is set in the “third instruction” field. Also, in the instruction information 131 illustrated in FIG. 20, the “BBB instruction” is set in the “first instruction” field of the item having “2” in the “item number” field, an “EEE instruction” is set in the “second instruction” field, and the “BBB instruction” is set in the “third instruction” field. Further, in the instruction information 131 illustrated in FIG. 20, a “CCC instruction” is set in the “first instruction” field of the item having “3” in the “item number” field, the “CCC instruction” is set in the “second instruction” field, and the symbol “−” is set in the “third instruction” field.

As will be described later, when the respective instructions set in the “first instruction” field, the “second instruction” field, and the “third instruction” field are transmitted in sequence a predetermined number of times or more within a predetermined period of time, the hypervisor 13 determines that the instructions are transmitted by malware. Specifically, for example, when the “BBB instruction”, the “EEE instruction”, and the “BBB instruction” are transmitted in sequence a predetermined number of times or more within a predetermined period of time, the hypervisor 13 determines that the instructions are transmitted by malware and malware operates on the OS 12. Accordingly, the hypervisor 13 may more accurately discern an instruction transmitted by malware and an instruction transmitted by an application 11 not infected with malware.

Although each item of the instruction information 131 illustrated in FIG. 20 includes three fields in each of which information corresponding to an instruction is to be set, but may include only two fields in each of which information corresponding to an instruction is to be set. Each item of the instruction information 131 illustrated in FIG. 20 may include four or more fields in each of which information corresponding to an instruction is to be set.

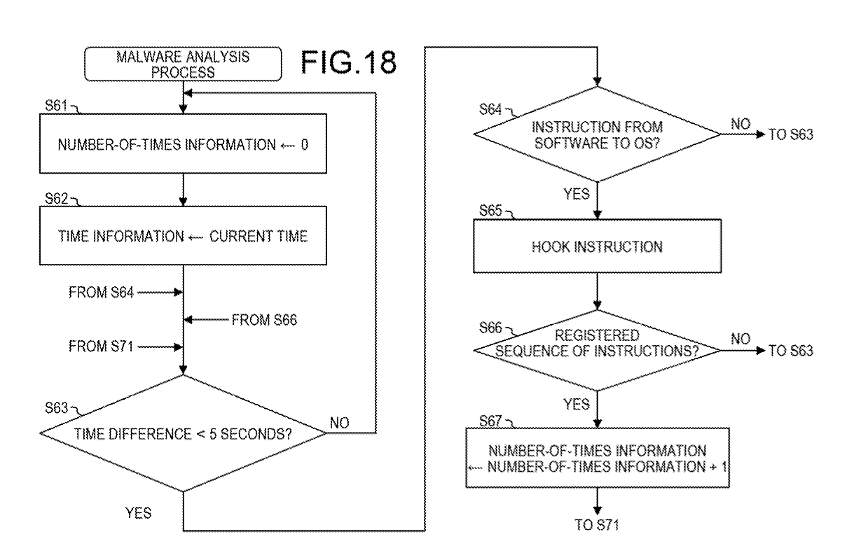

Referring back to FIG. 18, the instruction determination unit 113 sets “0” in the number-of-times information 132 (S61). The instruction determination unit 113 sets the current time in the time information 133 in which the time at the predetermined timing is maintained (S62).

Thereafter, the instruction determination unit 113 determines whether, for example, a difference between the current time and the time set in the time information 133 is within five seconds (S63). When it is determined that the difference between the current time and the time set in the time information 133 is within five seconds (YES at S63), the instruction acquisition unit 112 determines whether an instruction is transmitted from the application 11 to the OS 12 (S64). When it is determined that an instruction is transmitted from the application 11 to the OS 12 (YES at S64), the instruction acquisition unit 112 hooks the instruction detected at S64 (S65). When it is determined that an instruction is not transmitted from the application 11 to the OS 12 (NO at S64), the instruction determination unit 113 executes S63 again.

When it is determined that the difference between the current time and the time set in the time information 133 reaches five seconds (NO at S63), the instruction determination unit 113 executes S61 again.

The instruction determination unit 113 determines whether information corresponding to a sequence of instructions hooked at S65 is included in the instruction information 131 registered in the information storage area 130 (S66). When it is determined that the information corresponding to the sequence of the hooked instructions is included in the instruction information 131 (YES at S66), the instruction determination unit 113 adds “1” to a value set in the number-of-times information 132 (S67).

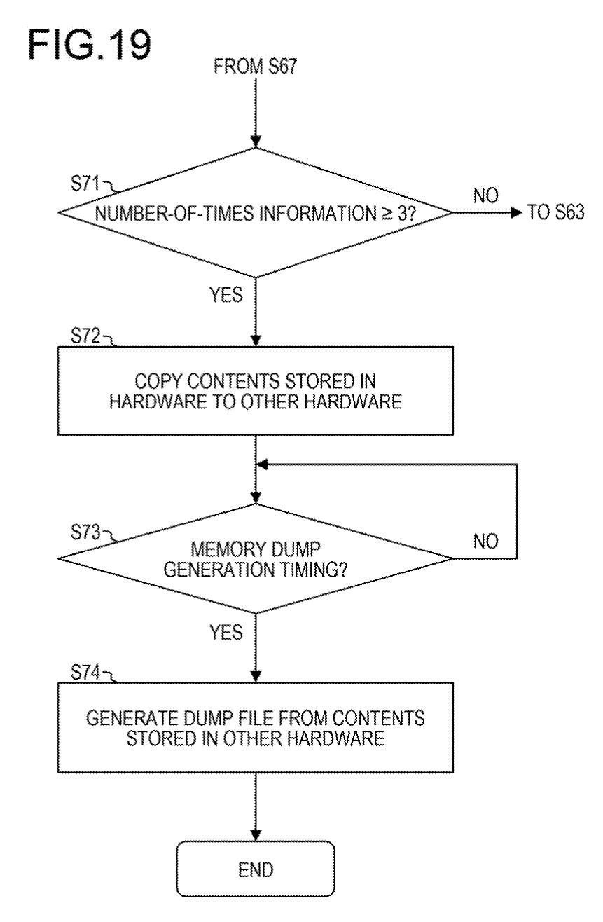

Thereafter, as illustrated in FIG. 19, the instruction determination unit 113 determines whether the value currently set in the number-of-times information 132 is greater than or equal to, for example, “3” (S71). When it is determined that the value set in the number-of-times information 132 is greater than or equal to “3” (YES at S71), the hardware controller 114 copies data stored in hardware (e.g., the memory 102) to other hardware (e.g., the storage medium 104) (S72).

When it is determined that the information corresponding to the sequence of the hooked instructions is not included in the instruction information 131 (NO at S66) or when it is determined that the value set in the number-of-times information 132 is not greater than or equal to “3” (NO at S71), the instruction determination unit 113 executes S63 again.

The instruction determination unit 113 may update the value set in the number-of-times information 132 for each sequence of instructions (each item of the instruction information 131 described for FIG. 20) at S67. The instruction determination unit 113 may determine whether a sequence of instructions transmitted three times or more within five seconds is present among the sequences of instructions, of which information is included in the instruction information 131 at S71. Accordingly, the instruction determination unit 113 may save data stored in the memory 102 only when transmission of the same sequence of instructions is performed a predetermined number of times within a predetermined period of time.

Thereafter, the dump generation unit 115 waits until the memory dump generation timing is reached (NO at S73). When it is determined that the memory dump generation timing is reached (YES at S73), the dump generation unit 115 generates a dump file from data stored in other hardware (the storage medium 104) (S74). The generated dump file may be saved in the storage medium 104 or another storage medium. The generated dump file may be output to an output device (not illustrated) or be transmitted to other devices through the external interface 103.

Accordingly, when an operation characteristic of malware is obvious, the hypervisor 13 may precisely discern an instruction transmitted by malware and an instruction transmitted by an application 11 not infected with malware. Therefore, the hypervisor 13 may more efficiently save data stored in the memory 102.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to an illustrating of the superiority and inferiority of the invention. Although the embodiments of the present invention have been described in detail, it should be understood that the various changes, substitutions, and alterations could be made hereto without departing from the spirit and scope of the invention.

What is claimed is:

1. A device for analyzing malware, the device comprising:
a memory configured to
store therein an instruction assumed to be transmitted to an operating system from malware; and
a processor coupled to the memory and the processor configured to
hook a first instruction transmitted to the operating system from an application,
determine whether the first instruction is stored in the memory, and
copy data stored in first hardware to second hardware different from the first hardware upon determining that the first instruction is stored in the memory, the first hardware being accessed by the operating system.

2. The device according to claim 1, wherein
the first instruction is an instruction for requesting information which indicates whether the application is executed in a virtual environment.

3. The device according to claim 1, wherein
the processor is configured to
copy data stored in the first hardware to the second hardware in a case where the first instruction is hooked a predetermined number of times or more within a predetermined period of time.

4. The device according to claim 1, wherein
the memory is configured to
store therein a sequence of instructions assumed to be transmitted to the operating system from malware, and
the processor is configured to
hook a first sequence of instructions transmitted to the operating system from the application,
determine whether the first sequence of instructions is stored in the memory, and
copy data stored in the first hardware to the second hardware upon determining that the first sequence of instructions is stored in the memory.

5. The device according to claim 4, wherein
the processor is configured to
copy data stored in the first hardware to the second hardware in a case where the first sequence of instructions is hooked a predetermined number of times or more within a predetermined period of time.

6. A method for analyzing malware, the method comprising:
hooking, by a computer, a first instruction transmitted to an operating system from an application;
determining whether the first instruction is stored in a memory, the memory storing therein an instruction assumed to be transmitted to the operating system from malware; and
copying data stored in first hardware to second hardware different from the first hardware upon determining that the first instruction is stored in the memory, the first hardware being accessed by the operating system.

7. The method according to claim 6, wherein
the first instruction is an instruction for requesting information which indicates whether the application is executed in a virtual environment.

8. The method according to claim 6, comprising:
copying data stored in the first hardware to the second hardware in a case where the first instruction is hooked a predetermined number of times or more within a predetermined period of time.

9. The method according to claim 6, wherein
the memory is configured to
store therein a sequence of instructions assumed to be transmitted to the operating system from malware, and
the method comprises:
hooking a first sequence of instructions transmitted to the operating system from the application;
determining whether the first sequence of instructions is stored in the memory; and
copying data stored in the first hardware to the second hardware upon determining that the first sequence of instructions is stored in the memory.

10. The method according to claim 9, comprising:
copying data stored in the first hardware to the second hardware in a case where the first sequence of instructions is hooked a predetermined number of times or more within a predetermined period of time.

11. A non-transitory computer-readable recording medium having stored therein a program that causes a computer to execute a process, the process comprising:
hooking a first instruction transmitted to an operating system from an application;
determining whether the first instruction is stored in a memory, the memory storing therein an instruction assumed to be transmitted to the operating system from malware; and
copying data stored in first hardware to second hardware different from the first hardware upon determining that the first instruction is stored in the memory, the first hardware being accessed by the operating system.

12. The non-transitory computer-readable recording medium according to claim 11, wherein
the first instruction is an instruction for requesting information which indicates whether the application is executed in a virtual environment.

13. The non-transitory computer-readable recording medium according to claim 11, the process comprising:
copying data stored in the first hardware to the second hardware in a case where the first instruction is hooked a predetermined number of times or more within a predetermined period of time.

14. The non-transitory computer-readable recording medium according to claim 11, wherein
the memory is configured to
store therein a sequence of instructions assumed to be transmitted to the operating system from malware, and
the process comprises:
hooking a first sequence of instructions transmitted to the operating system from the application;
determining whether the first sequence of instructions is stored in the memory; and
copying data stored in the first hardware to the second hardware upon determining that the first sequence of instructions is stored in the memory.

15. The non-transitory computer-readable recording medium according to claim 14, the process comprising:
copying data stored in the first hardware to the second hardware in a case where the first sequence of instructions is hooked a predetermined number of times or more within a predetermined period of time.
